(19) United States
(12) Patent Application Publication
(10) Pub. No.: US 2005/0019002 A1
(43) Pub. Date: Jan. 27, 2005

(54) Digital information recording apparatus and method, and video recording and reproduction apparatus

(75) Inventors: Kenichiro Okabe, Osaka (JP); Kazuhide Ishihara, Osaka (JP)

Correspondence Address: OSHA & MAY L.L.P., 1221 MCKINNEY STREET, HOUSTON, TX, 77010, US

(73) Assignee: Funai Electric Co., Ltd., Osaka (JP)

(21) Appl. No.: 10/897,534

(22) Filed: Jul. 23, 2004

(30) Foreign Application Priority Data
Jul. 25, 2003 (JP) 2003-201723

(51) Int. Cl. H04N 5/76; H04N 5/781

(52) U.S. Cl. 386/46; 386/125

(57) ABSTRACT

In a personal video recorder (PVR) writing and recording TS data in units of blocks while moving a head over a disk recording unit of HDD, in a recording mode, a data management unit retrieves free blocks in the disk recording unit for recording the TS data formed of blocks, specifies one of the retrieved free blocks for which the degree of seek movement amount of the head becomes minimum when recording of the TS data is started from the relevant free block, and determines the relevant free block as the recording start position for the TS data. Every recording of TS data is started from the position guaranteeing the minimum degree of seek movement amount of the head, so that the seek time upon access can be reduced for each TS data.

### BACKGROUND OF THE INVENTION

1. Field of the Invention

The present invention relates to an apparatus and method for recording digital information, and a video recording and reproduction apparatus provided therewith. More particularly, the present invention relates to a digital information recording apparatus and method and a video recording and reproduction apparatus having a function to seek a free space for recording.

2. Description of the Background Art

A way of shortening the average seek time upon data accesses to improve data writing and reading speeds to and from a storage device is disclosed, e.g., in Japanese Patent Laying-Open No. 09-311765.

As shown in FIG. 12 of the publication, the apparatus described therein divides data to be written into data blocks A0-A7 of prescribed size and writes the data blocks in discrete areas on a recording surface 16 of a disk, rather than writing the data in continuous areas. This prevents the situation where upon occurrence of sequential accesses to data stored in the innermost and outermost portions of recording surface 16, the seek movement amount of the head (hereinafter, also referred to as the “seek amount”) becomes maximum continuously, leading to an increase of the overhead due to the seek time.

As such, in the apparatus described in the publication, data are stored in units of data blocks in places on the recording surface, instead of being stored in continuous areas. Thus, even in the case where a plurality of data items are accessed sequentially in a prescribed access unit, e.g., in the data block unit, the increase of the overhead due to the seek time as described above will not occur continuously.

The technique disclosed in Japanese Patent Laying-Open No. 09-311765, however, merely reduces the average seek time for whole data, by recording a plurality of blocks constituting the data in discrete areas to prevent continuous occurrence of the situation where the overhead due to the seek time becomes maximum. The technique cannot reduce the seek amount of the head for each data item.

### SUMMARY OF THE INVENTION

An object of the present invention is to provide a digital information recording apparatus and method and a video recording and reproduction apparatus that can reduce the seek movement amount of the head for each item of digital information to be recorded.

To achieve the above-described object, the digital information recording apparatus according to an aspect of the present invention writes and reads digital information in units of blocks to and from a recording region in a digital information recording medium, with a head moved relative to the digital information recording medium. The apparatus includes: a free block retrieving unit that retrieves free blocks in the recording region for recording the digital information formed of a plurality of blocks; and a recording start position determining unit that determines, as a recording start position, one of the free blocks retrieved by the free block retrieving unit for which degree of seek amount involving the above-described relative movement becomes minimum when recording of the digital information formed of the plurality of blocks is started from the relevant free block. Here, the seek amount refers to the amount of movement of the head for seek.

With this configuration, recording of each of digital information formed of a plurality of blocks can be started from the position guaranteeing the minimum degree of seek amount. Thus, it is possible to shorten the seek time upon access for each of the digital information formed of blocks.

Preferably, the recording start position determining unit has a seek amount calculating unit that calculates, for each of the free blocks retrieved by the free block retrieving unit, the degree of the seek amount involving the above-described relative movement when the recording of the digital information formed of the plurality of blocks is started from the relevant free block.

Accordingly, it is possible to calculate and obtain the degree of seek amount for determining the free block to be the recording start position.

Preferably, the seek amount calculating unit has a block count unit that counts, for each of the free blocks retrieved by the free block retrieving unit, the number of used blocks existing between the relevant free block and a next free block in a prescribed recording direction. The seek amount calculating unit calculates, for each of the free blocks retrieved by the free block retrieving unit, an average value of the counted values by the block count unit for all the free blocks existing in the prescribed recording direction with respect to the relevant free block as the degree of seek amount.

As such, the degree of seek amount for determining the free block to be the recording start position can be calculated, for each of the free blocks, as the average value of the counted values of the block count unit for all the free blocks located in the prescribed recording direction with respect to the relevant free block. Accordingly, it is readily possible to obtain the degree of seek amount for each free block.

Preferably, the digital information is digital information of video, and the digital information recording apparatus is provided in a recording and reproduction apparatus of the video. As such, it is possible to shorten the seek time upon accesses (writing or reading) for recording or reproduction of the video digital information.

Preferably, the recording region is a region where digital information is recorded for implementing the time shifting function. Thus, the seek time required for accessing (writing or reading) the digital information in the recording region at the time of time shifting reproduction can be shortened. As a result, it is possible to perform the seek operation in time for update of the reproduction screen, which prevents distortion of the images that would otherwise occur.

To achieve the above-described object, the digital information recording method according to another aspect of the present invention is for writing and reading digital information in units of blocks to and from a recording region in a digital information recording medium, with a head moved relative to the digital information recording medium. The method includes: the free block retrieving step of retrieving free blocks in the recording region for recording the digital information formed of a plurality of blocks; and the recording start position determining step of determining, as a recording start position, one of the free blocks retrieved in the free block retrieving step for which degree of seek amount involving the above-described relative movement becomes minimum when recording of the digital information formed of the plurality of blocks is started from the relevant free block.

Accordingly, every time digital information formed of a plurality of blocks is to be recorded, a free block guaranteeing the minimum degree of seek amount for recording the relevant digital information is determined as the recording start position. Thus, the seek time for accessing (writing or reading) the digital information can be shortened.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a PVR (Personal Video Recorder) and its peripheral devices according to an embodiment of the present invention.

FIG. 2 shows, by way of example, contents of a management table according to the embodiment of the present invention.

FIG. 3 shows, by way of example, a recorded state of information in a recording region according to the embodiment of the present invention.

FIG. 4 is a flowchart illustrating procedure for determining a recording start position according to the embodiment of the present invention.

### DESCRIPTION OF THE PREFERRED EMBODIMENTS

Hereinafter, embodiments of the present invention will be described with reference to the drawings.

Although it is described that digital information based on video signals is recorded on a recording medium, the digital information recorded is not limited to video of moving or still pictures. For example, it may include data of sound, program, and text (characters).

Further, although readable and writable disk recording media (magnetic disks such as HDD (Hard Disk Drive), optical disks such as DVD (Digital Versatile Disk), magneto-optical disks and others) are assumed herein as the recording medium for which a head seeks data in the recording region, the present invention is not limited thereto. A tape recording medium of digital information such as D-VHS (Digital Video Home System) may also be employed, as long as it can record meaningful information to be recorded or reproduced and information for management of the recorded state of the relevant information.

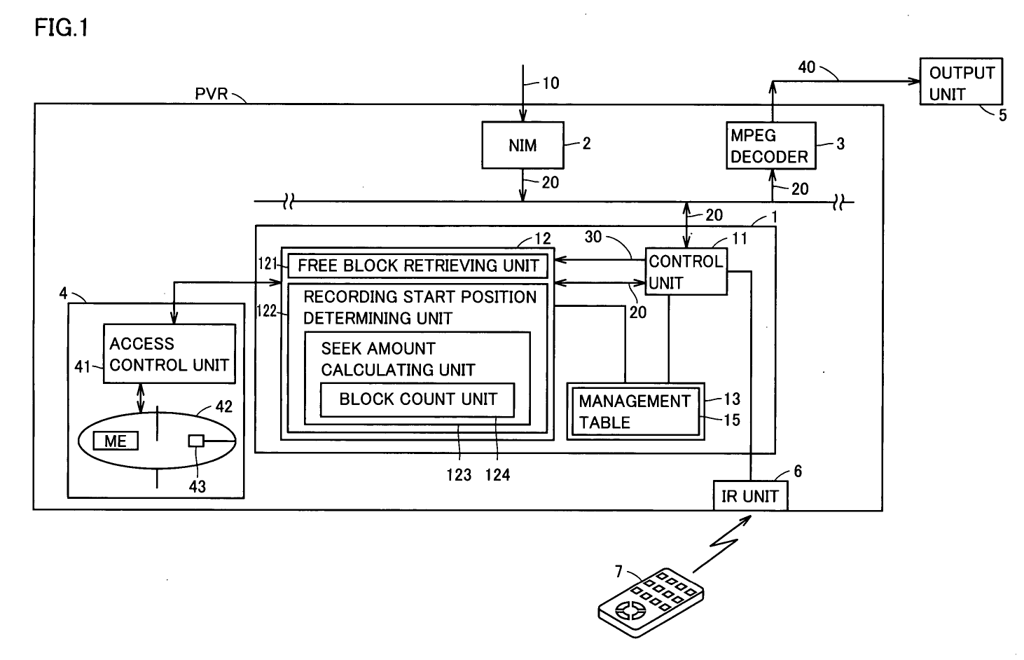

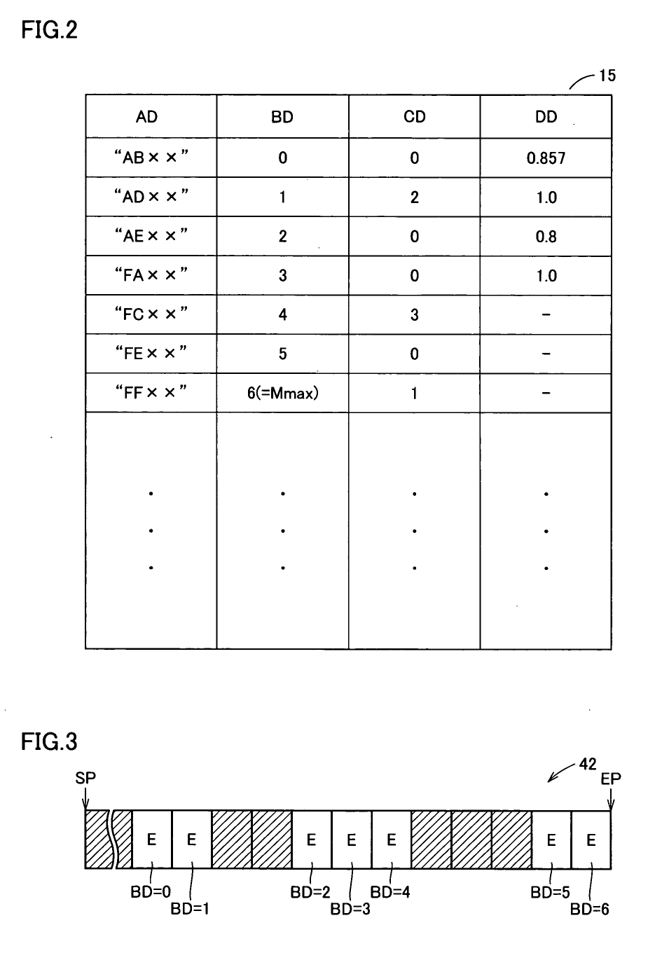

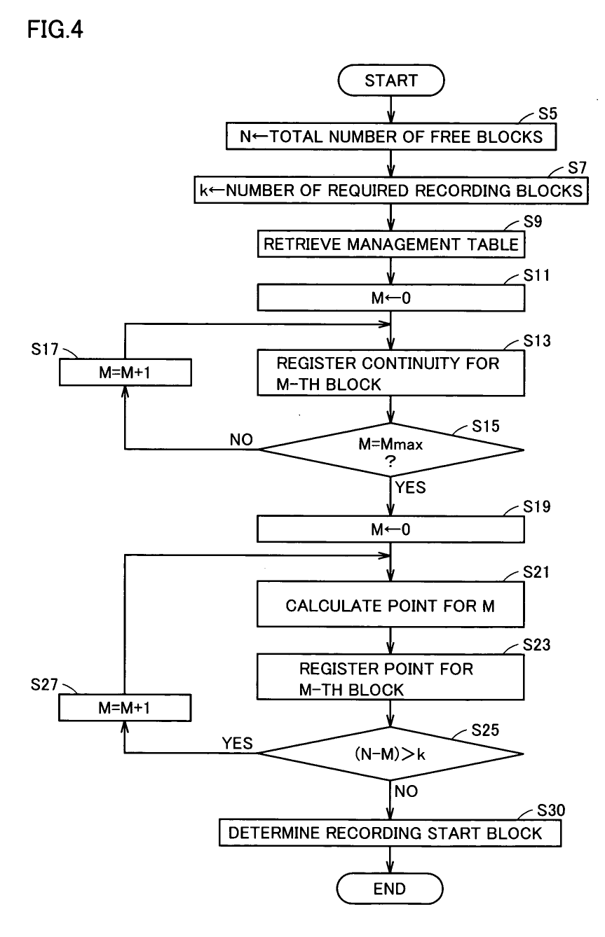

FIG. 1 shows a configuration of a PVR (Personal Video Recorder) having recording and reproducing functions and its peripheral devices according to an embodiment of the present invention. FIG. 2 shows by way of example contents of a management table, FIG. 3 shows by way of example a recorded state of information in a recording region, and FIG. 4 shows procedure for determining a recording start position according to the embodiment of the present invention.

Referring to FIG. 1, the PVR inputs, from an input terminal (not shown), a RF (Radio Frequency) signal 10 that is a high-frequency video signal of DTV (Digital Television) broadcast or the like. The PVR processes the signal, and outputs a video signal 40 to be viewed at an output unit 5 that is, e.g., an externally connected TV (Television) set.

The PVR includes a CPU (Central Processing Unit) 1 for control of the whole, a NIM (Network Interface Module) 2 receiving and processing RF signal 10 and outputting computer-processible TS (Transport Stream) data 20, an MPEG decoder 3 receiving and decoding TS data 20 in accordance with the MPEG (Moving Pictures Experts Group) method and outputting video signal 40, a HDD 4 for recording/reproduction of TS data 20, and an IR (InfraRed) unit 6 receiving and processing an infrared-modulated designation signal from an external user-manipulable remote controller 7 and providing the designation signal to CPU 1.

CPU 1 has a control unit 11 and a data management unit 12 having their functions implemented by programs, and also has a memory 13 for storage of various data including a management table 15.

HDD 4 has an access control unit 41, a disk recording unit 42 as the recording medium, and a head 43 moving over a recording surface of the rotating disk recording unit 42 for scanning and writing/reading of data. Although head 43 performs both recording and reproduction of data, separate heads may be provided therefor.

Access control unit 41 controls the rotational speed of disk recording unit 42, positioning for movement of head 43, and data writing/reading by means of head 43.

Disk recording unit 42 has a region (hereinafter, referred to as “information recording region”) where digital information based on video to be recorded/reproduced or the like is recorded, and a management region ME where data for management of a free space of the information recording region is stored. In the information recording region, data is recorded in a prescribed recording unit (hereinafter, referred to as “block”). Management region ME stores, for each of a plurality of blocks located from the start position to the end position of the information recording region of disk recording unit 42, information indicating whether it is a used block having valid information actually recorded thereon, or a free block having invalid information recorded thereon and available for overwrite and storage of new data, as well as data indicating the position of the block in the information recording region. Access control unit 41 records/writes such information. Here, the invalid information refers to information having been written but made invalid by erasing or the like, and information of the block immediately after initialization and having no information written thereon. It is assumed that “defragmentation” is not performed for disk recording unit 42.

Data management unit 12 has a free block retrieving unit 121 and a recording start position determining unit 122. Recording start position determining unit 122 has a seek amount calculating unit 123 including a block count unit 124.

When writing is designated from control unit 11, data management unit 12 refers to management table 15, and determines a block as an optimal writing start position in disk recording unit 42. Data management unit 12 then designates access control unit 41 to start writing of TS data 20 supplied from control unit 11 from the position of the determined block.

When reading of TS data 20 from disk recording unit 42 is designated by R/W signal 30 designating data reading/writing, data management unit 12 designates access control unit 41 to read the data from disk recording unit 42 based on the reading start position (i.e., the writing start position determined upon recording of the relevant TS data 20) designated along with R/W signal 30. TS data 20 read by access control unit 41 is provided to control unit 11 via data management unit 12. Control unit 11 outputs the read TS data 20 to MPEG decoder 3. MPEG decoder 3 decodes the received TS data 20, and outputs the resulting video signal 40 to output unit 5. In output unit 5, video corresponding to the read TS data 20 is reproduced and displayed.

In disk recording unit 42, as shown, e.g., in FIG. 3, data is recorded from the start position SP to the end position EP of the information recording region where information to be recorded, such as digital information based on videos signals, is stored. In FIG. 3, shaded blocks correspond to the used blocks having valid information recorded thereon, and the remaining blocks correspond to free blocks E. It is assumed that information is recorded in units of blocks sequentially in a direction from the start position SP to the end position EP.

When data is erased at random from the information recording region of disk recording unit 42, free blocks E are generated in discrete areas, as shown in FIG. 3. In the case where new, consecutive TS data 20 are to be written into a plurality of free blocks E, free blocks E may be located at physically discontinuous places, e.g., over different tracks, leading to an increase of overhead due to repeated jumping of head 43 over tracks during the seek operation for free blocks E.

To avoid such a situation, the present embodiment is configured as follows. When recording of TS data 20 is requested, prior to commencement of the recording, data management unit 12 calculates and determines one of free blocks E as the recording start position that can reduce the seek amount of head 43 to the minimum. Recording of TS data 20 is then started from the determined position.

It is assumed that, in the case where TS data 20 to be recorded are input successively to control unit 11 at the same time as recording is requested, the input TS data 20 are temporarily stored in a buffer (not shown) in control unit 11 during the time for calculation as described above. When the block as the recording start position is determined by calculation, the recording of TS data 20 read out of the buffer is started from the thus determined block.

Referring to FIG. 2, contents of management table 15, based on the recorded state shown in FIG. 3, are explained by way of example. Management table 15 includes, for each of all free blocks E from the start position SP to the end position EP of the information recording region in disk recording unit 42, block position data AD indicating the position (e.g., address) of the relevant block in disk recording unit 42, free block number data BD indicating the number assigned to the relevant free block in ascending order as 0, 1, 2 . . . from the free block nearest to the start position SP, continuity data CD, and point data DD.

Continuity data CD indicates the number of used blocks existing between free block E having free block number data BD of “i” (i=0, 1, 2, 3 . . . ) and a next free block E in the direction of end position EP (opposite to the direction of start position SP). It becomes “0” when the adjacent block in the end position EP direction is a free block E. It is assumed that the adjacent block of the block at end position EP is not a free block E, since there is no block in the direction opposite to the start position SP direction.

Referring to FIG. 3, continuity data CD of free blocks E having free block number data BD of “0”, “2”, “3” and “5” each show the value of “0”, and those of free blocks E having free block number data BD of “1”, “4” and “6” show the values of “2”, “3” and “1”, respectively.

Data management unit 12 calculates point data DD for each free block E based on the following expression 1.

$$DD ( x ) = \frac{{\sum }_{i = x}^{N - 1} CD ( i )}{N - x} ( x = 0 , 1 , … , k - 1 ) \qquad ( expression 1 )$$

where “x” represents free block number data BD, “DD(x)” represents point data DD of the block having free block number data BD of “x”, “CD(i)” represents continuity data CD of the i-th block having free block number data BD of “i”, the variable “N” represents the total number of free blocks E from the start position SP to the end position EP, and the variable “k” represents the number of blocks of the data to be recorded. In the above expression 1, for each free block E, an average of continuity data CD of all free blocks E located in the end position EP direction (recording direction) with respect to the relevant free block E is calculated as point data DD.

As seen from the expression 1, point data DD(x) indicates the degree of the seek amount of head 43 at the time of writing when data writing of the same amount (block length) is started from the relevant free block. Thus, among point data DD(x) (x=0, 1, 2, . . . , k-1) obtained by the expression 1, one having the smallest value indicates the lowest degree of seek amount of head 43 at the time of writing, and accordingly, the position (block) indicated by the corresponding block position data AD is determined as the recording start position.

In the case where the data to be recorded has a size of four blocks, when the above expression 1 is applied in the state shown in FIG. 3, DD(0)=(0+2+0+0+3+0+1)/(7-0)=0.857, DD(1)=(2+0+0+3+0+1) (7-1)=1, DD(2)=4/5=0.8, and DD(3)=4/4=1, among which the minimum value is DD(2). As such, in the recorded state shown in FIG. 3, the position indicated by block position data AD corresponding to the free block number data BD of “2” is determined as the recording start position. The seek amount of head 43 can be reduced when the data is recorded on four free blocks E located in the end position EP direction from this location (four free blocks E having free block number data BD of “2” to “5” in FIG. 3). After the recording, if the state of the information recording region does not change from that of FIG. 3, the seek amount of head 43 upon reproduction can be reduced as well.

Hereinafter, the procedure for determining the recording start position upon data recording is explained with reference to the flowchart of FIG. 4.

When a signal designating recording of TS data 20 output from NIM 2 is input to control unit 11 from remote controller 7 via IR unit 6, control unit 11 starts processing according to the process flowchart shown in FIG. 4.

Firstly, control unit 11 designates a recording operation to data management unit 12. In response, free block retrieving unit 121 of data management unit 12 searches management region ME via access control unit 41, and reads each free block E in the information recording region of disk recording unit 42 and the corresponding position data, and sets the total number of read free blocks as the variable “N” (step S (hereinafter, simply referred to as “S”) 5).

Recording start position determining unit 122 of data management unit 12 determines the recording start position in the following manner. Firstly, it obtains the total number of recording blocks required for recording TS data 20 to be recorded, and sets it as the variable “k” (S7). Here, for example, control unit 11 obtains the number of required recording blocks based on the program broadcasting time within EPG (Electrical Program Guide) information included in TS data 20 to be recorded that is supplied from NIM 2, and provides the same to data management unit 12.

It is noted that the total number of required recording blocks may be determined based on information such as recording time, recording mode (recording bit rate (bit/sec) of equal speed, triple speed or the like) indicated by the designating signal from remote controller 7 at the time of unattended recording, instead of being obtained from the EPG information.

Next, seek amount calculating unit 123 of data management unit 12 calculates the degree of seek amount in the following manner. Firstly, management table 15 is retrieved (S9). Specifically, data management unit 12 retrieves management table 15, and registers the position data for each free block E received from access control unit 41 in S5 as the block position data AD for each free block, and also registers the free block number data BD on management table 15.

Thereafter, seek amount calculating unit 123 of data management unit 12 sets a temporary variable “M” for control to “0” (S11). Block count unit 124 calculates continuity data CD by the above-described procedure, while incrementing variable M by 1 at a time (S17), until variable M becomes a prescribed value of “Mmax”, i.e., for all the free blocks E detected, and then registers the calculated continuity data CD on management table 15 (S13).

When continuity data CD is registered for every free block E (YES in S15), data management unit 12 sets temporary variable M back to “0” (S19). Thereafter, seek amount calculating unit 123 calculates point data DD for free block E having free block number data BD of “M” according to the above-described expression, while incrementing variable M by 1 at a time (S27), and stores the obtained point data DD in management data 15 corresponding to the relevant free block E (S21, S23).

The calculation and registration of point data DD are performed until “(N-M)>k” no longer holds in S25, i.e., the number of remaining free blocks E becomes equal to the number “k” of required recording blocks. Recording start position determining unit 122 then determines the position indicated by block position data AD corresponding to the point data DD having the minimum value among those registered in management table 15 as the recording start position (recording start block) (S30). The procedure for determining the block of recording start position is thus completed.

Although point data DD is recorded on management table 15 every time point data DD is calculated in the procedure of FIG. 4, the present invention is not limited thereto. Every time point data DD is obtained, it may be compared with the previous-calculated point data DD, and only the smaller value may be held (with the other value discarded). The position indicated by block position data AD corresponding to the point data DD ultimately held may be determined as the recording start position.

Further, although the program according to the flowchart of FIG. 4 is made to start upon designation of a recording operation, the start timing is not limited thereto. For example, the recording start position may be calculated by executing the program every time the recorded state as shown in FIG. 3 is changed, assuming that data of a prescribed size is to be recorded.

Still further, in the present embodiment, the seek operation has been explained to involve movement of the head while the movement (rotation) of the disk is stopped, since the case of accessing information on a disk-shaped recording medium using a head has primarily been assumed. The manner of movement, however, is not limited thereto. As explained at the beginning of the description of the present embodiment, the recording medium may be a tape recording medium, in which case the seek operation will involve running of the tape with the head being fixed. Thus, the seek operation of the present embodiment can be said to be the operation of moving the head relative to the recording medium.

As described above, according to the present embodiment, in the case where TS data 20 of digital information formed of a plurality of blocks of video signals is to be recorded when the required data areas on disk recording unit 42 are located discontinuously, the recording start position, or, free block E that can reduce the seek amount of head 43 to the minimum can be calculated and determined.

As a result, in the case of performing time shifting for so-called “catch-up reproduction” using a prescribed recording region of disk recording unit 42, the problem that the seek amount of head 43 and hence the overhead for the time shifting increases because the blocks recorded with the video data exist in discrete areas within the relevant recording region, leading to distortion of the reproduced images at output unit 5, can be prevented. Further, the seek amount, i.e., the seek movement amount of head 43 in the recording region can be reduced, so that long life is guaranteed for the devices such as head 43, disk recording unit 42 and others.

As such, calculating the degree of seek amount of head 43 for each free block E when recording is started from the relevant block position (point data DD) and determining the recording start position based on the calculated point data DD can shorten the seek time upon data access.

Although the present invention has been described and illustrated in detail, it is clearly understood that the same is by way of illustration and example only and is not to be taken by way of limitation, the spirit and scope of the present invention being limited only by the terms of the appended claims.

1. A digital information recording apparatus writing and reading digital information in units of blocks to and from a recording region in a digital information recording medium, with a head moved relative to said digital information recording medium, comprising:
free block retrieving means for retrieving free blocks in said recording region for recording said digital information formed of a plurality of blocks; and
recording start position determining means for determining, as a recording start position, one of said free blocks retrieved by said free block retrieving means for which degree of a seek movement amount of said head involving said relative movement becomes minimum when recording of said digital information formed of the plurality of blocks is started from the relevant free block .

2. The digital information recording apparatus according to claim 1, wherein said recording start position determining means has seek amount calculating means for calculating, for each of said free blocks retrieved by said free block retrieving means, said degree of the seek movement amount of said head involving said relative movement when the recording of said digital information formed of the plurality of blocks is started from the relevant free block.

3. The digital information recording apparatus according to claim 2, wherein
said seek amount calculating means has block count means for counting, for each of said free blocks retrieved by said free block retrieving means, the number of used blocks existing between the relevant free block and a next free block in a prescribed recording direction, and
said seek amount calculating means calculates, for each of said free blocks retrieved by said free block retrieving means, an average value of the counted values by said block count means for all said free blocks existing in said prescribed recording direction with respect to the relevant free block as said degree of the seek movement amount of said head.

4. The digital information recording apparatus according to claim 3, wherein said digital information is digital information of video, and said digital information recording apparatus is provided in a recording and reproduction apparatus of said video.

5. A digital information recording method for writing and reading digital information in units of blocks to and from a recording region in a digital information recording medium, with a head moved relative to said digital information recording medium, comprising:
the free block retrieving step of retrieving free blocks in said recording region for recording said digital information formed of a plurality of blocks; and
the recording start position determining step of determining, as a recording start position, one of said free blocks retrieved in said free block retrieving step for which degree of seek movement amount of said head involving said relative movement becomes minimum when recording of said digital information formed of the plurality of blocks is started from the relevant free block.

6. A video recording and reproduction apparatus, provided with a digital information recording apparatus writing and reading video digital information in units of blocks to and from a recording region in a digital information recording medium, with a head moved relative to said digital information recording medium, and reproducing said digital information from said digital information recording medium,
said digital information recording apparatus including:
free block retrieving means for retrieving free blocks in said recording region for recording said digital information formed of a plurality of blocks; and
recording start position determining means for determining, as a recording start position, one of said free blocks retrieved by said free block retrieving means for which degree of a seek movement amount of said head involving said relative movement becomes minimum when recording of said digital information formed of the plurality of blocks is started from the relevant free block,
said recording start position determining means having seek amount calculating means for calculating, for each of said free blocks retrieved by said free block retrieving means, said degree of the seek movement amount of said head involving said relative movement when the recording of said digital information formed of the plurality of blocks is started from the relevant free block, and
said seek amount calculating means having block count means for counting, for each of said free blocks retrieved by said free block retrieving means, the number of used blocks existing between the relevant free block and a next free block in a prescribed recording direction, and said seek amount calculating means calculating, for each of said free blocks retrieved by said free block retrieving means, an average value of the counted values by said block count means for all said free blocks existing in said prescribed recording direction with respect to the relevant free block as said degree of the seek movement amount of said head.
